(19) United States
(12) Patent Application Publication
(10) Pub. No.: US 2026/0006381 A1
(43) Pub. Date: Jan. 1, 2026

(54) METHOD AND A SYSTEM FOR DETERMINING A LOUDSPEAKER PERFORMANCE PROFILE FOR SOUND FIELD MANAGEMENT OF AN ACOUSTIC SYSTEM

(71) Applicant: HARMAN BECKER AUTOMOTIVE SYSTEMS GmbH, Karlsbad-Ittersbach (DE)

(72) Inventors: Christopher OATES, Bamberg (DE); Adrian VON DEM KNESEBECK, Münich (DE); Fanyu MENG, Oberschleissheim (DE); Friedrich VON TÜRCKHEIM, Hamburg (DE); Johannes KLEIN, Kehl (DE)

(21) Appl. No.: 19/191,435

(22) Filed: Apr. 28, 2025

(30) Foreign Application Priority Data
Jun. 26, 2024 (EP) 24184652.6

(51) Int. Cl. H04R 3/14; H04R 3/04

(52) U.S. Cl. CPC H04R 3/14; H04R 3/04

(57) ABSTRACT

A method carried out at a processing entity is provided. The method comprises determining, for each loudspeaker of an acoustic system comprising multiple loudspeakers, sound pressure level (SPL) data and total harmonic distortion (THD) data over different frequencies and different amplifier gain values associated with different SPLs. The method further comprises determining, for each loudspeaker based on the THD and the SPL data, a loudspeaker performance profile forming a plurality of loudspeaker performance profiles; and providing the plurality of loudspeaker performance profiles for an adaptation of a sound field generated by the acoustic system.

### CROSS-REFERENCE TO RELATED APPLICATIONS

This application claims priority benefit of Application No. EP24184652.6, titled “A METHOD AND A SYSTEM FOR DETERMINING A LOUDSPEAKER PERFORMANCE PROFILE FOR SOUND FIELD MANAGEMENT OF AN ACOUSTIC SYSTEM,” and filed Jun. 26, 2024. The subject matter of this related application is hereby incorporated by reference herein in its entirety.

### BACKGROUND

### Field of the Various Embodiments

The present application relates to a system and a method for determining a loudspeaker performance profile based on automatically acquired total harmonic distortion data and using the profile for an adaptation of a sound field generated by an acoustic system.

### DESCRIPTION OF THE RELATED ART

KR101337842B1 is directed at a sound tuning method to automate sound tuning or equalization at a passenger space in a vehicle. In KR101337842B1, a useful sound signal, which does not include undesired interference or noise, is played through a loudspeaker. A sound pressure value is measured at a plurality of locations where a plurality of sound pressures are produced. A target transfer function expressing the desirable transfer characteristic of the acoustic system is provided for tuning a delay line and an equalizing filter in the acoustic system. The delay of the delay line is adjusted. An amplitude response of the equalizing filter is adjusted. A step of adjusting the delay and the amplitude response includes a step of calculating a desired output signal, a step of calculating error signals, and a step of generating total error signals, a step of adjusting the delay and the amplitude response.

KR100897971B1 is directed at an audio system installed in a listening space that may include a signal processor and a plurality of loudspeakers. The audio system may be tuned with an automated audio tuning system to optimize the sound output of the loudspeakers within the listening space. The automated audio tuning system may provide automated processing to determine at least one of a plurality of settings, such as channel equalization settings, delay settings, gain settings, cross-over settings, bass optimization settings and group equalization settings. The settings may be generated by the automated audio tuning system based on an audio response produced by the loudspeakers in the audio system. The automated tuning system may generate simulations of the application of settings to the audio response to optimize tuning.

In view of the above, there is a need to improve automated tuning of an acoustic system.

### SUMMARY

These needs are met by the features defined in the independent claims. The dependent claims define additional embodiments.

A method is provided. The method is carried out at a processing entity. The method comprises determining, for each loudspeaker of an acoustic system comprising multiple loudspeakers, sound pressure level, SPL, data and total harmonic distortion, THD, data over different frequencies and different amplifier gain values associated with different SPLs. The method further comprises determining, for each loudspeaker based on the THD and the SPL data, a loudspeaker performance profile forming a plurality of loudspeaker performance profiles. The method further comprises providing the plurality of loudspeaker performance profiles for an adaptation of a sound field generated by the acoustic system.

According to some further aspects, a processing entity is provided. The processing entity comprises at least one computer processor configured to carry out steps of a method. In an aspect, the method comprises determining, for each loudspeaker of an acoustic system comprising multiple loudspeakers, sound pressure level, SPL, data and total harmonic distortion, THD, data over different frequencies and different amplifier gain values associated with different SPLs. The method further comprises determining, for each loudspeaker based on the THD and the SPL data, a loudspeaker performance profile forming a plurality of loudspeaker performance profiles. The method further comprises providing the plurality of loudspeaker performance profiles for an adaptation of a sound field generated by the acoustic system.

According to some further aspects, a computer program product is provided. The computer program product comprises computer readable instructions, stored on an electronic storage medium, that, when executed on a processing entity, cause the processing entity to carry out steps according to a method. In an aspect, the method comprises determining, for each loudspeaker of an acoustic system comprising multiple loudspeakers, sound pressure level, SPL, data and total harmonic distortion, THD, data over different frequencies and different amplifier gain values associated with different SPLs. The method further comprises determining, for each loudspeaker based on the THD and the SPL data, a loudspeaker performance profile forming a plurality of loudspeaker performance profiles. The method further comprises providing the plurality of loudspeaker performance profiles for an adaptation of a sound field generated by the acoustic system.

As will become more apparent from the detailed description, automated determination of the THD and SPL data can provide improved accuracy of the data as compared to conventional ways of determining the THD and the SPL data. Improved accuracy of the THD and the SPL data in turn can facilitate improvements in tunning of the acoustic system.

The features set out above and those described below may be used not only in the corresponding combinations explicitly set out, but also in other combinations or in isolation, without departing from the scope of protection of the present disclosure.

### BRIEF DESCRIPTION OF THE DRAWINGS

The present disclosure will now be described more fully hereinafter with reference to the accompanying drawings, in which embodiments of the disclosure are shown. However, this disclosure should not be construed being limited to the embodiments set forth herein. Rather, these embodiments are provided so that this disclosure will be thorough and complete, and will fully convey the scope of the disclosure to those skilled in the art. Like numbers refer to like elements throughout.

FIG. 1 schematically shows an acoustic system 100 according to one of a number of embodiments.

FIG. 2a schematically shows an embodiment 200a for obtaining THD and SPL data according to one of a number of embodiments.

FIG. 2b schematically shows an embodiment 200b for generating and using a per-speaker performance profile for automatic tunning of an acoustic system according to one of a number of embodiments.

FIG. 2c schematically shows an embodiment 200c for automatic tunning of an acoustic system according to one of a number of embodiments.

FIG. 3a schematically shows a loudspeaker performance profile 300a of a mid-range loudspeaker showing a maximum SPL value produced over frequency for a given THD threshold value according to one of a number of embodiments.

FIG. 3b schematically shows SPL and THD data for a 3-way loudspeaker system from which optimal cross-over settings for a cross-over filter can be determined according to one of a number of embodiments.

FIG. 4 schematically shows a method 400 according to one of a number of embodiments.

FIG. 5 schematically shows a method 500 according to one of a number of embodiments.

FIG. 6 schematically shows a processing entity 1000 according to one of a number of embodiments.

### DETAILED DESCRIPTION

The properties, features and advantages described above and the way in which they are achieved will become clearer and more clearly understood in association with the following description of the exemplary embodiments which are explained in greater detail in connection with the drawings. For simplicity and illustrative purposes, the present disclosure is described by referring mainly to an exemplary embodiment thereof. In the following description, numerous specific details are set forth in order to provide a thorough understanding of the present disclosure. However, it will be readily apparent to one of ordinary skill in the art that the present disclosure may be practiced without limitation to these specific details. In this description, well-known methods and structures have not been described in detail so as not to unnecessarily obscure the present disclosure.

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical or electronic devices may be combined with each other and/or separated in any manner based on the particular type of electrical implementation that is desired. It is recognized that any circuit or other electrical or electronic device (e.g., an acoustic system) disclosed herein may include any number of microcontrollers, a graphics processor unit (GPU), integrated circuits, memory devices and software which co-act with one another to perform operation(s) disclosed herein. In addition, any one or more of the electrical or electronic devices may be configured to execute a program code (for an infotainment system) that is embodied in a non-transitory computer readable medium programmed to perform any number of the functions as disclosed.

In the following, embodiments of the disclosure will be described in detail with reference to the accompanying drawings. It is to be understood that the following description of embodiments is not to be taken in a limiting sense. The scope of the disclosure is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

In general, the present application relates to a system and a method for determining a loudspeaker performance profile based on automatically acquired total harmonic distortion and sound pressure level data and using the profile for an adaptation of a sound field generated by an acoustic system. The present application further relates to identification of tunning parameters such as cross-over filter settings accounting for total harmonic distortion and sound pressure level in reproduced sound generated by the acoustic system. In some examples, the tunning parameters may comprise equalizer filter settings for room response correction adaptation.

Rooms can greatly impact the audio quality of an acoustic system which is why sound field management is typically a critical step. Many conventional systems generally don't consider the capabilities of the loudspeakers. Total harmonic distortion (THD) measurements may be advantageous to understand a loudspeaker's optimal frequency range and performance at different sound pressure levels (SPLs). Multi-speaker acoustic systems comprising multiple loudspeakers may advantageously apply cross-over settings which may enable all loudspeakers to play together optimally. It may be advantageous to calculate optimal filter positions and type for all loudspeakers to play together optimally. Not taking into account the speakers' capabilities may result in a sub-standard performance, such as in some conventional acoustic systems, as a speaker's non-linear behaviour at different SPLs typically impacts the performance. Not taking into account the speakers' capabilities can push the acoustic system beyond its capabilities and damage speakers. Determining THD data at different SPLs can provide a performance profile to inform downstream sound field management tasks such as cross-over identification and room response correction to deliver an optimal sound at any SPL.

In general, the total harmonic distortion (THD) may refer to harmonic distortion present in an acoustic sound and may be defined as a ratio of the sum of the powers of all harmonic components of the acoustic sound to the power of the fundamental frequency of the acoustic sound. A distortion factor is typically used as a synonym for THD. THD may be calculated from an electric signal recorded by an acoustic detector (a microphone) in response to an acoustic sound produced by a loudspeaker. For example, THD may be calculated from a voltage (measured by the microphone) by using a formula:

$$THD = \frac{\sqrt{{V}_{2}^{2} + {V}_{3}^{2} + … + {V}_{n}^{2}}}{{V}_{1}} \times 100 \% ,$$

where Vn is a root mean square (RMS) value of an n-th harmonic and V1 is a RMS value of the fundamental component (fundamental frequency).

Voltage signal V(t) measured over time, t, by an acoustic detector (microphone) can be converted into a frequency spectrum V(f) by applying Fourier transform. Fundamental and harmonic components may be determined from the frequency spectrum V(f). For example, fundamental component V1 may be located at the frequency of a sine tone generated by a signal generator, reproduced by a loudspeaker and measured by the acoustic detector. Harmonic components V2 to Vn may be located at integer multiples of the fundamental frequency.

In audio systems, lower distortion (i.e., lower THD value) generally means that the components in a loudspeaker (amplifier or microphone or other acoustic equipment) produce a more accurate reproduction of a recorded sound.

Harmonic distortion (THD values above zero) can potentially widen the frequency spectrum of the output sound (reproduced sound) from a loudspeaker by adding signals at multiples of a reference sound signal (e.g., sine tone).

Sound pressure levels, SPL, may be obtained from a measured signal (e.g., voltage signal V) measured by a microphone in response to an audio signal reproduced by a loudspeaker. For example, a microphone may convert the acoustic pressure waves into an electrical signal (voltage, V), which can be recorded and analysed further.

If the microphone provides a voltage signal, it may be converted to SPL using the microphone's sensitivity or a calibration factor, S. The sensitivity or a calibration factor S may be given in volts per pascal (V/Pa). The sound pressure p (t) can be calculated using:

$$p ( t ) = \frac{V ( t )}{S} ,$$

where V(t) is the voltage signal from the microphone over time t.

Then, a root mean square, RMS, sound pressure over a time interval can be calculated. The RMS value may be referred to as a statistical measure of the magnitude of the varying sound pressure. For a time signal p (t), the RMS sound pressure can be calculated using the formula:

$${p}_{rms} = \sqrt{\frac{1}{T} {\int }_{0}^{T} {p ( t )}^{2} dt} ,$$

where T is the duration of the time interval over which the measurement is made. Then, the SPL may be calculated in decibels (dB) and using the RMS sound pressure according to a formula:

$$SPL = 20 {log}_{10} ( \frac{{p}_{rms}}{{p}_{0}} ) ,$$

where p0 is the reference sound pressure, typically 20 μPa (the threshold of hearing in air).

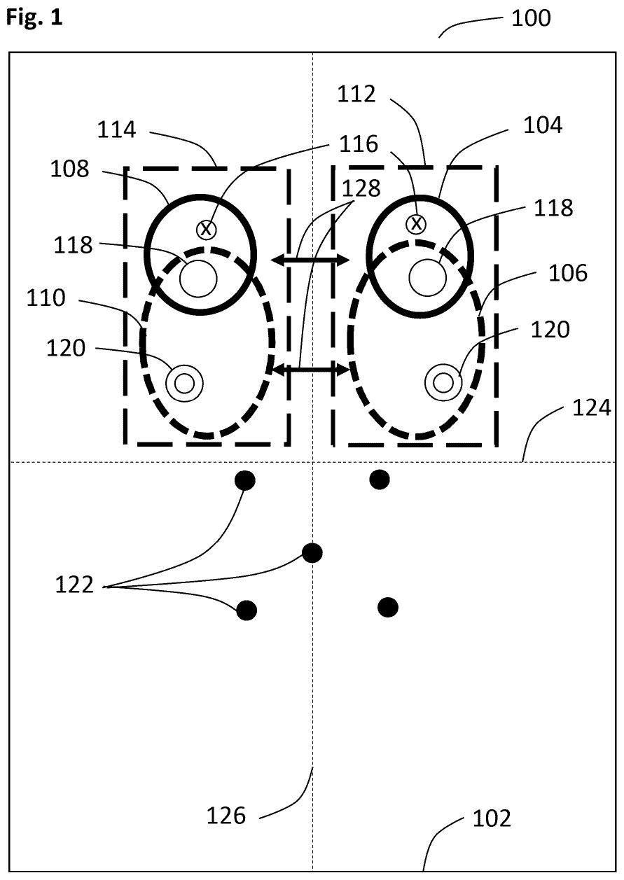

FIG. 1 schematically shows an acoustic system 100 according to one of a number of embodiments.

Acoustic system 100 may be located in a room 102. Acoustic system 100 may comprise one or more pairs of loudspeakers (or simply, speakers), e.g., a pair of speakers within a region 104; a pair of speakers within a region 106; a pair of speakers within a region 108; a pair of speakers within a region 110.

A pair of speakers within a region 104 may comprise two different types of loudspeakers (a tweeter 116 and a mid-range 118).

A pair of speakers within a region 106 may comprise two different types of loudspeakers (a woofer 120 and a mid-range 118).

A pair of speakers within a region 108 may comprise two different types of loudspeakers (a tweeter 116 and a mid-range 118 speaker).

A pair of speakers within a region 110 may comprise two different types of loudspeakers (a woofer 120 and a mid-range 118 speaker).

Regions 104, 106, 108, 110 may be sub regions of a bigger region. Regions 104, 106, 108, 110 may overlap or may be separated in space. For example, regions 104, 106 may be a part of a right-side spatial region 112. Regions 108, 110 may be a part a left-side spatial region 114.

Sound reproduced by acoustic system 100 may be measured at one or more listening positions 122 for determining the THD and SPL data. The measurement data may be provided to or obtained by the processing entity. The processing entity may control the measurement process and receive the measurement data for processing in order to determine the THD and SPL data.

Multiple loudspeakers may be grouped into spatial regions (e.g., regions 104, 106, 108, 110, 112, 114). Multiple loudspeakers may be grouped into spatial regions (e.g., regions 104, 106, 108, 110, 112, 114) symmetrically. The symmetry may be with respect to a transverse axis 124 and or a longitudinal axis 126.

In some examples, cross-overs may be set to optimize the acoustic system response in the listening area (a room 102). Optimizing the acoustic system response in the listening area may refer to achieving an optimal cross-over response between pairs of speakers within a region 104, 106, 108, 110 and cross-over response across regions. A plurality of loudspeakers performance profiles (comprising THD and SPL data) may be used for determining said cross-over responses.

In some examples, the method of the current disclosure may involve grouping one or more loudspeakers from the multiple loudspeakers into at least two spatial regions (e.g., region 112, and region 114) comprising a first spatial region 112 and a second spatial region 114 for a cross-region adjustment 128 of the one or more settings of the one or more cross-over filters. The first spatial region 112 may comprise at least a first loudspeaker (e.g., tweeter 116) and the second spatial region comprises at least a second loudspeaker (e.g., tweeter 116). The method may further involve identifying the one or more settings of the one or more cross-over filter based on a loudspeaker performance profile of the first loudspeaker (e.g. tweeter 116 in region 112) and a loudspeaker performance profile of the second loudspeaker (e.g., tweeter 116 in region 114) to jointly optimize the performance of the two loudspeakers.

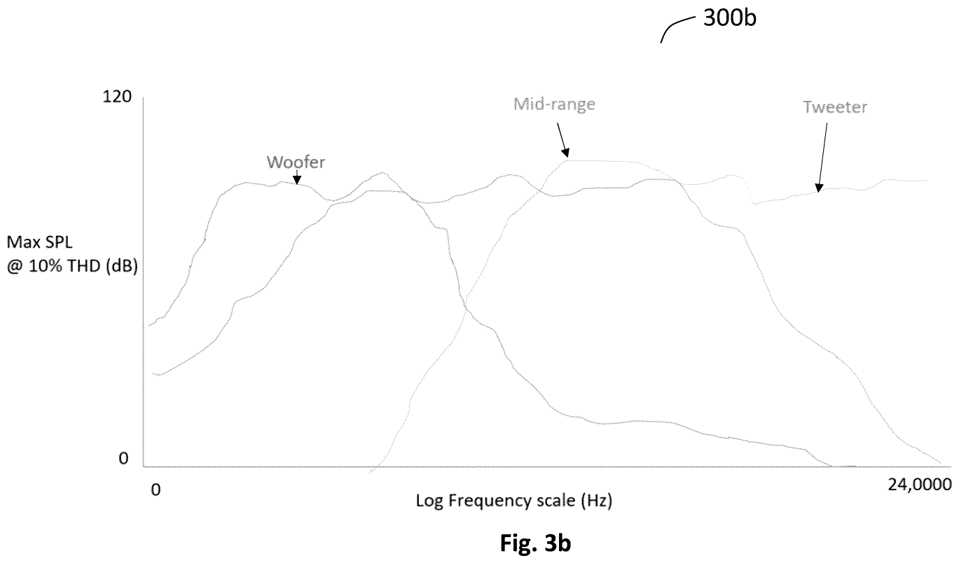

In some examples, the method of the current disclosure may involve identifying at least two loudspeakers of at least two types (e.g., mid-range 118 and tweeter 116 speakers), the at least two loudspeakers being located at at least one spatial region (e.g., region 104 or 108) for cross-type adjustments of the one or more settings of the cross-over filter. The at least two loudspeakers may comprise a loudspeaker of a first type (e.g., mid-range 118) and a loudspeaker of a second type (e.g., tweeter 116). The method may further involve identifying the one or more settings for the cross-over filter based on a loudspeaker performance profile of the loudspeaker of the first type (e.g., mid-range 118) and a loudspeaker performance profile of the loudspeaker of the second type (e.g., tweeter 116). For example, the settings may account for the scenario that a mid-range 118 speaker has a higher SPL in the mid-range frequency, as illustrated in FIG. 3b, where the mid-range speaker performs better than the tweeter in said mid-range frequency range, while tweeter 116 performs better in a higher frequency range.

In some examples, the method may involve recording reproduced acoustic sound by the at least one acoustic detector (e.g., a microphone) placed at multiple listening positions 122 comprising at least two listening positions 122. The method may further involve identifying the one or more settings for the cross-over filter for each loudspeaker (e.g., for each tweeter 116, mid-range 118, woofer 120 speaker types and/or a variation thereof) for the multiple listening positions 122. The method may further involve pairing the multiple loudspeakers into one or more pairs by type (tweeter 116, mid-range 118, woofer 120 speaker types and a variation thereof based on frequency range of the speaker for which it is made of) and by one or more spatial regions (e.g., a pair of speakers of tweeter 116 type in region 104 and region 108, where spatial regions 104 and 108 are different regions). Each pair may comprise at least two different types of loudspeakers located in the same (e.g., a tweeter 116 and a mid-range 118 located in one region 104 or region 112) or different spatial regions (e.g., tweeter 116 and woofer 120 located in different regions 104 and 106, respectively). The method may further involve identifying one or more relative settings for a cross-over filter between loudspeakers of each pair for the multiple listening position for the adaptation of the sound field at the multiple listening positions 122. Optionally, when the one or more pairs comprises more than one pair, identifying one or more optimal relative settings for cross-over filters for corresponding pairs of loudspeakers.

For example, the acoustic system 100 may be a 3-way speaker system comprising a tweeter 116, mid-range 118 and woofer 120. The acoustic system 100 may comprise two 3-way speaker systems, one 3-way speaker system may be located in a right-side spatial region 112 and another one may be located in a left-side spatial region 114.

In some other examples, the acoustic system 100 may be a 4-way speaker system comprising a woofer, a mid-range, a tweeter and a variation of.

Thus, the acoustic system 100 may be a multi-way speaker system.

The terms “speaker” and “loudspeaker” in the context of the current disclosure may be used interchangeably, as well as terms “sound system” and “acoustic system”, among other.

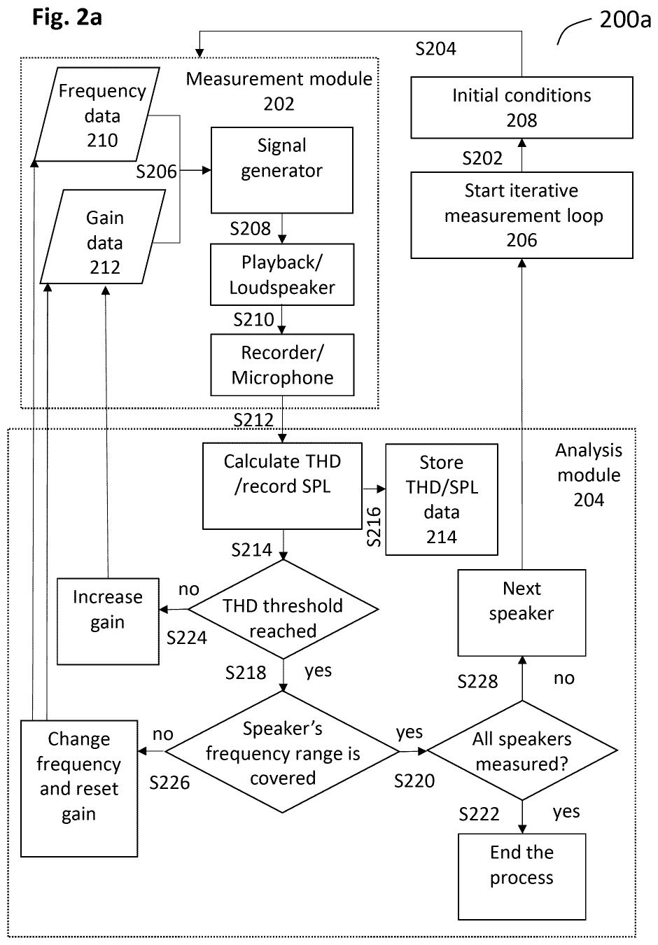

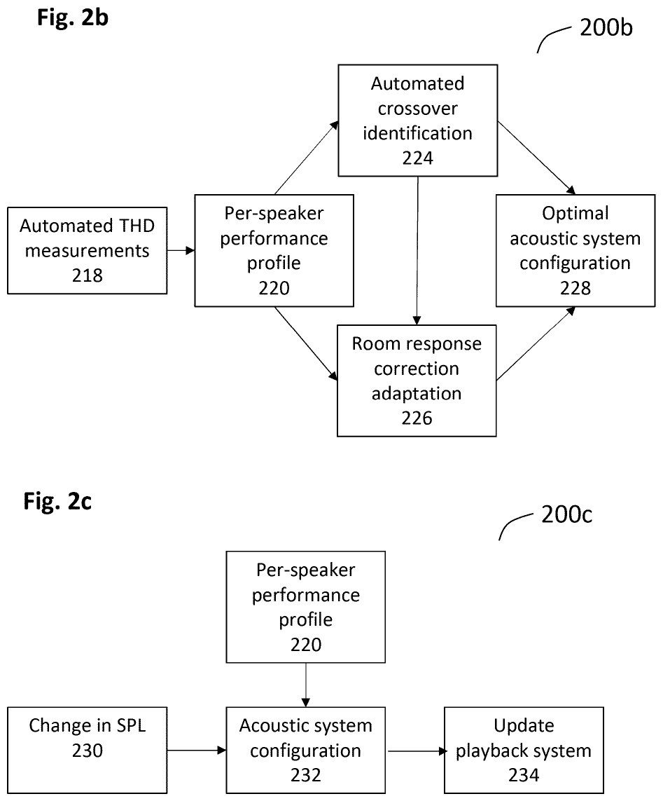

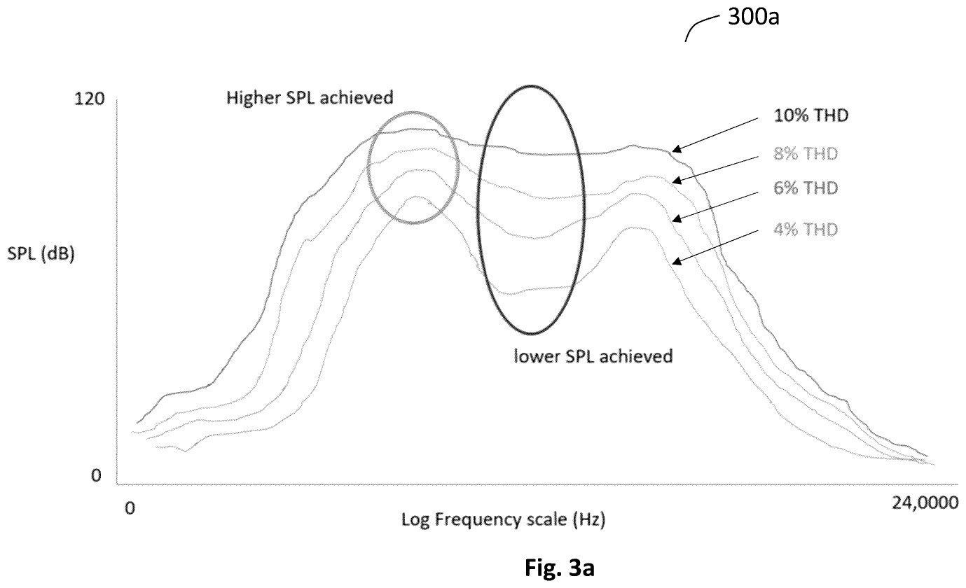

FIG. 2a schematically shows an embodiment 200a for obtaining THD and SPL data according to one of a number of embodiments.

A system for obtaining THD and SPL data may comprise a measurement module 202 and an analysis module 204.

The analysis module 204 may be controlled by the processing entity or may be a part of it. In case then the analysis module 204 is a standalone module controlled by the processing entity, the analysis module may comprise a computer processor. The computer processor of the analysis module 204 may be communicatively coupled to the processor of the processing entity. Alternatively, the analysis module may be a part of the processing entity, not requiring a standalone, separate, computer processor. Similarly, the measurement module 202 may be controlled by the processing entity or may be a part of it.

The measurement module 202 and the analysis module 204 may be communicatively coupled via a computer interface and jointly controlled by the processing entity through the computer interface to provide fully automated data acquisition (i.e., recorded sound) and analysis of the acquired data for fully automated tunning of the sound filed generated by the acoustic system, especially when amplifier gain changes necessitating adjustment of tunning parameters to the new gain.

Thus, embodiment 200a may allow for adapting acoustic system tunning parameters and using said adapted parameters for automated tunning of the sound field generated by the acoustic system 100. In some examples, the acoustic system tunning parameters may comprise settings of one or more equalizing filters (EQ) and one or more cross-over filters determined based on a plurality of loudspeaker performance profiles.

In some examples, adapting acoustic system tunning parameters may involve using the THD/SPL data to inform an automated tuning process of the amplifier gain dependent behaviour of the loudspeaker which can then be used to tailor the tuning settings (acoustic system tunning parameters) for different amplifier gain levels. For example, acoustic system tunning parameters may comprise different equalizing filters (EQs) and/or cross-over filters settings, channel gain, delay, and/or alike.

In some examples, one or more settings for the equalizing filter may comprise one or more equalizing filter parameters (e.g., one or more frequency bands and one or more equalizer gain values associated with the one or more frequency bands, and/or one or more quality factors) for room response correction. For example, frequency bands may comprise bands where a room where the acoustic system is to be located causes constructive and destructive interference that need to be compensated. In order to correct the room response, the one or more equalizer gain values may be adapted according to one or more SPL values of the plurality of loudspeaker performance profiles.

In some examples, one or more settings for each of the one or more cross-over filters may comprise at least one cut-off frequency value identified based on the THD and the SPL data of each of the plurality of loudspeaker performance profiles thereby optimizing joint performance of the multiple loudspeakers.

For example, there may be one or two cross-over filters for one loudspeaker of multiple loudspeakers of acoustic system 100. Each cross-over filter may comprise a cut-off frequency. A single cross-over filter typically cuts one frequency range. A cross-over filter may be a low-pass cross-over filter that may cut out the frequencies above the cut-off frequency. A cross-over filter may be a high-pass cross-over filter which cuts out the frequencies below the cut-off. Thus, one loudspeaker typically requires either a low-pass cross-over filter or a high-pass cross-over filter, or both, a low-pass cross-over filter and a high-pass cross-over filter.

A process for obtaining THD and SPL data may be iterative (i.e., having an iterative measurement loop 206). At the beginning of the iterative measurement loop, initial conditions 208 may be provided. The initial conditions may comprise frequency and amplifier gain provided from frequency data 210 and gain data 212. The amplifier gain may relate to an amplifier of acoustic system 100. After each iteration of the iterative measurement loop 206, THD/SPL data 214 is produced that may be stored on an electronic medium and used for generating loudspeaker performance profiles.

The process for obtaining THD and SPL data may comprise steps S202-S228.

At S202, an iterative measurement loop is initiated (started).

At S204, initial conditions are provided.

At S206, frequency and gain data are provided.

At S208, a sine tone is generated.

At S210, the sine tone is reproduced.

At S212, reproduced sound is recorded.

At S214, THD/SPL data is calculated.

At S216, THD/SPL data is stored.

At S218, if a THD threshold is reached, it is checked if speaker's frequency range is covered.

At S220, if the range is covered, it is checked if all speakers are measured.

At S222, if all speakers are measured, the process ends.

At S224, if the THD threshold is not reached, amplifier gain is increased and the measurement loop is started over.

At S226, if the frequency range is not covered, the frequency range is changed, amplifier gain is reset and the measurement loop is started over.

At S228, if not all speakers are measured, the process moves to next speaker and the measurement loop starts over.

Thus, in some examples, when the first value or the subsequent value of the THD reaches the first threshold value (at step S218), and when the first loudspeaker's frequency range exceeds the initial frequency range (at step S226), a higher or a lower frequency range relative to the initial frequency range may be selected and the amplifier gain value may be reset to an initial gain value for calculating another value of the THD associated with the higher or the lower frequency range and the initial gain value. The step of checking if the whole frequency range is covered, as well as step of checking if all gains are covered, may be advantageous to maximise the performance of each loudspeaker at all output levels.

In some examples, a recommended range for a loudspeaker may not be available from a technical specification (from a manufacturer of a loudspeaker), and thus, a measurement can start from an initial frequency range (e.g., 100 Hz to 1000 Hz) and proceed to a higher or lower frequency range. For example, the initial range may be a range of 100 Hz to 1000 Hz, typically used for acoustic measurements. A lower range may cover frequencies below 100 Hz and a higher range may cover frequencies above 1000 Hz up to 24 kHz. In another example, the initial range may cover mid-range frequencies as illustrated in FIG. 3b for the mid-range speaker. This range may be obtained (received automatically) from the technical specifications of the loudspeaker, when it is available, or by performing a test measurement comprising one or more measurement data points. Thus, selecting the initial frequency range can be based on the manufacturer's data for each loudspeaker, or based on the test measurement identifying frequency range of the loudspeaker (e.g., based on a rough measurement comprising a few measurement points, or additionally, more fine measurement comprising more measurement points providing a higher measurement resolution).

In some examples, incrementally adjusting gain, as illustrated at step S214, may provide a safety feature to prevent damaging the loudspeaker while characterizing the loudspeaker.

In some examples, obtaining the subsequent value of the THD and the corresponding SPL value comprises, for the initial frequency range from the frequency data and a subsequent amplifier gain value from the gain data, generating (at step S208), by the processing entity, a subsequent sine tone; causing, by the processing entity, the first loudspeaker to reproduce (at step S210) the subsequent sine tone; causing, by the processing entity, the at least one acoustic detector to record (at step S212) reproduced sound; and calculating (at step S214), by the processing entity, the subsequent value of the THD and the corresponding SPL value.

In some examples, a frequency resolution may be based on ⅓ octave spacing. For example, when starting at 100 Hz, one octave above would be 200 Hz, and one octave below would be 50 Hz providing a plurality of frequency data points for the frequency data, as well as for frequency values illustrated in FIGS. 3a and 3b. A sine tone may be generated for each frequency value.

Embodiment 200a may facilitate THD/SPL measurements over different frequencies and amplifier gain values to produce the loudspeaker performance profile for each speaker in the acoustic system. In turn, the loudspeaker performance profiles may facilitate simultaneous cross-over identification for all loudspeakers jointly. The loudspeaker performance profiles may also facilitate room response correction (room EQ) adaptation based on all loudspeaker performance profiles of the acoustic system jointly.

Embodiment 200a may provide detection if an acoustic system's response (based on cross-overs and EQ settings) changes in accordance with the THD measurements over varying amplifier gain values.

Embodiment 200a may facilitate automatic calculation of cross-over filters based on THD/SPL data.

Thus, embodiment 200a may provide several advantages such as automation of determining loudspeaker performance profile. Said automation may enable more accurate measurements and more accurate THD/SPL data. More accurate THD/SPL data in turn may provide more optimal cross-over and room EQ settings.

FIG. 2b schematically shows an embodiment 200b for generating and using a per-speaker performance profile for automatic tunning of an acoustic system according to one of a number of embodiments.

A process for generating and using a per-speaker performance profile may comprise automated THD/SPL measurements 218, e.g., provided by the measurement module 202 and analysis 204 modules described in the context of FIG. 2a.

Said automated THD/SPL measurements can provide per speaker performance profile 220 (comprising, e.g., THD/SPL data 214, speaker identifiers, threshold values and amplifier gain values). The per speaker performance profile 220 can be used for automated cross-over identification 224 and room response correction adaptation 226 thereby providing optimal acoustic system configuration 228.

Thus, embodiment 200b can provide automated THD/SPL measurements to produce per-speaker performance profiles which can then be used to set optimal cross-over filters and adapt the room response correction to arrive at an optimal acoustic system configuration.

FIG. 2c schematically shows an embodiment 200c for automatic tunning of an acoustic system according to one of a number of embodiments.

Embodiment 200c relates to a change in the acoustic system's SPL and/or amplified gain setting. Embodiment 200c can provide adaptation to changes in the acoustic system's output SPL or changes in amplifier gain that correlate to the SPL data captured during the acoustic system THD/SPL measurements. Said adaptation allows for the acoustic system to continue to generate optimal sound field.

Thus, once a change in SPL 230 occurs, per-speaker performance profile can be used to adapt acoustic system configuration 232 resulting in updating playback system 234.

Embodiment 200c enables automatically capturing the speakers' performance profiles and using them to automatically identify optimal cross-over settings and adapt room response correction for different SPLs.

FIG. 3a schematically shows a loudspeaker performance profile 300a of a mid-range loudspeaker showing a maximum SPL value produced over frequency for a given THD threshold value according to one of a number of embodiments.

The representation of the loudspeaker performance profile 300a such as illustrated by FIG. 3a can provide a visualization of a maximum SPL value produced over frequency for a given THD threshold value. The loudspeaker performance profile may comprise a maximal SPL achieved over a frequency rage at a range of THD thresholds (e.g. 2 to 10%) which can capture the loudspeaker's performance capabilities at this frequency range. As illustrated in FIG. 3a, higher THD threshold value correlates with higher SPL values. Lower SPL values may indicate poor performance of the loudspeaker. Higher THD values may also indicate poor performance, and vice versa. Said poor performance may be accounted for by adapting the acoustic system tunning parameters based on the plurality of loudspeaker performance profiles.

In some examples, a change in SPL may be caused by the acoustic system 100 by turning up the volume (causing amplifier gain change). For a given volume (amplifier gain) there may be a corresponding loudspeaker performance profile forming a data matrix comprising SPL values over frequencies for given THD thresholds and gains. Thus, a loudspeaker performance profile, LPP, may be a four-dimensional matrix (4-D), comprising a 2-D matrix {SPL, frequency} for a 1-D vector of {gain} and a 1-D vector of {THD threshold}. The LPP profile may further comprise a vector of calculated THD values for each gain value, where each calculated THD value may be comparted to a threshold value. For example, SPLs in FIG. 3a correspond to 4% THD threshold value, 6% THD threshold value, 8% THD threshold value, 10% THD threshold value. SPLs in FIG. 3a are plotted over multiple frequencies. Four amplifier gain values (corresponding to four SPL curves in FIG. 3a) are not shown in FIG. 3a. A calculated THD value for a given gain and frequency range may be compared to a THD threshold value. As long as calculated THD value reaches the THD threshold value, calculated THD/SPL values can be associated with this threshold value and stored on a storage medium as illustrated at step 216 in FIG. 2a. Said stored values can be further used for forming the loudspeaker performance profile.

Plots in FIG. 3a may be referred to as a representation of a loudspeaker performance profile of one loudspeaker. As will be further described in the context of FIG. 3b, plots in FIG. 3b represent three loudspeaker performance profiles of loudspeakers of three types (tweeter, mid-range and woofer). In each of FIGS. 3a and 3b amplifier gain values are not shown but each loudspeaker performance profile in these figures is associated with one amplifier gain value from the gain data.

The processing entity can manage the sound field, generated by the acoustic system, by using the corresponding loudspeaker performance profile (i.e., corresponding to amplifier gain) to tune/optimize the acoustic system tunning parameters (EQ/cross-over filters).

A change in volume (amplifier gain) would typically result in a change in SPL that may be indicative to use a corresponding loudspeaker performance profile to identify a tuning parameter set for an amplifier gain associated with the change in the SPL.

For each volume value (amplifier gain) there may be a corresponding tuning parameter set (e.g., consisting of EQ filters and cross-over filters) identified based on the plurality of loudspeaker profiles. Thus, a change in volume (correlated with a change in SPL) can trigger the usage of a different set of acoustic system tunning parameters.

In some examples, the method may involve determining a plurality of tunning parameter sets, each tunning parameter set being determined for a different amplifier gain value from the gain data and each tunning parameter set being determined from the one or more settings for the one or more equalizing filters and the one or more cross-over filters. The method may further involve automatically selecting a tunning parameter set from the plurality of tunning parameter sets for a corresponding amplifier gain value. The method may further involve causing the acoustic system to apply selected tunning parameter set for the adaptation of the sound field generated by the acoustic system, wherein the adaptation is triggered by an amplifier gain change. For example, a tunning parameter set can be selected for a gain value from the gain data comparable to the new (changed) amplifier gain value.

FIG. 3b schematically shows SPL and THD data for a 3-way loudspeaker system from which optimal cross-over settings for a cross-over filter can be determined according to one of a number of embodiments.

As mentioned in the context of FIG. 3a, plots in FIG. 3b represent three loudspeaker performance profiles of loudspeakers of three types (tweeter, mid-range and woofer). Said three loudspeaker performance profiles were obtained for a frequency range from 0 to 24 KHz. Said three loudspeaker performance profiles were obtained for THD threshold value equal to 10%. However, this value is exemplary and any value above zero can be used as a THD threshold value. However, THD values over 10% threshold may be associated with poorer performance of loudspeakers.

In some examples, one or more settings for each of the one or more cross-over filters may comprise at least one cut-off frequency value identified based on the THD and the SPL data of each of the plurality of loudspeaker performance profiles thereby optimizing joint performance of the multiple loudspeakers. For example, there may be one or two cross-over filters for one loudspeaker of multiple loudspeakers of acoustic system 100. Each cross-over filter may comprise a cut-off frequency. For example, for the woofer in FIG. 3b there may be one cross-over filter necessary having one cut-off frequency (low frequency). The mid-range speaker in the context of FIG. 3b may require two cross-over filters, each having one cut-off frequency (low and high frequency). For example, one loudspeaker can have multiple EQ filters and up to two cross-over filters, a lower and an upper cross-over filter.

In some examples, the method of the current disclosure may involve, determining, from the plurality of the loudspeaker performance profiles, a pair of candidate loudspeakers in the same spatial region, the pair of candidate loudspeakers having at least one common cross-over frequency range. When the pair of candidate loudspeakers are available in the same spatial region, the method may further involve selecting a candidate loudspeaker from the pair having a higher SPL value for the same or lower THD value as compared to the other candidate of the pair, wherein the pair of candidate loudspeakers comprise two loudspeakers of different types.

For example, when two loudspeakers (mid-range and tweeter FIG. 3b) are available for mid-range frequency, the mid-range speaker could be selected as it has a higher SPL for the same THD threshold and frequency range. In the context of this example, referring back to FIG. 1, mid-range and tweeter speakers may be a mid-range 118 and tweeter 116 located in a region 112 or a region 114 as illustrated in FIG. 1. Thus, a pair of loudspeakers (i.e., a mid-range 118 and tweeter 116) may be located in the same spatial region, 112 or 114. In another example, a pair of candidate loudspeakers (mid-range 118 and tweeter 116) may be located in one spatial region 104, and a similar pair (mid-range 118 and tweeter 116) may be located in another spatial region 108. Thus, multiple loudspeakers may be grouped by types (tweeter, mid-range, woofer, etc.) for cross-type adjustment and by spatial regions for cross-region adjustment and/or within region adjustment of acoustic system tunning parameters.

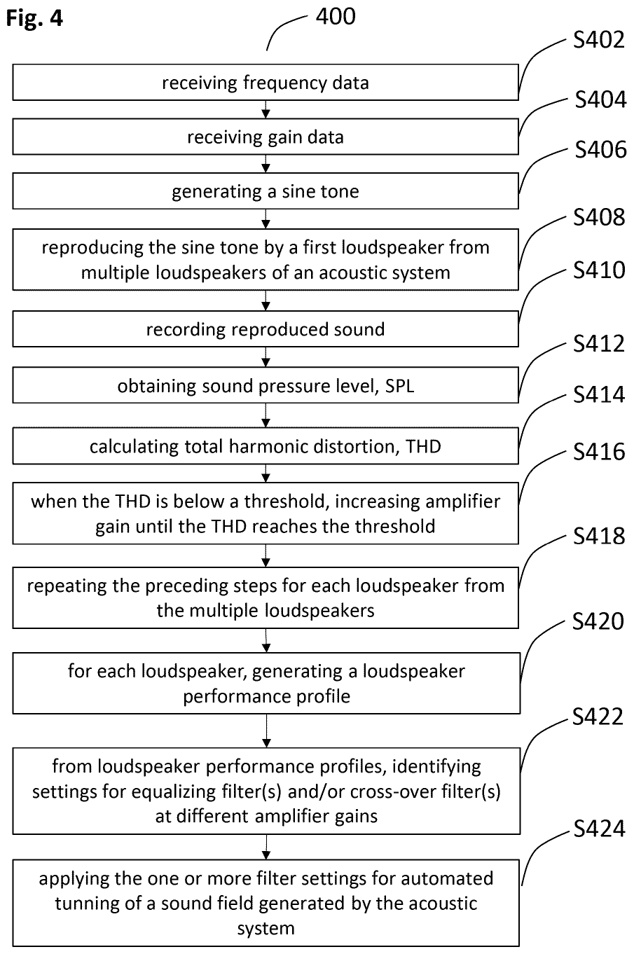

FIG. 4 schematically shows a method 400 according to one of a number of embodiments.

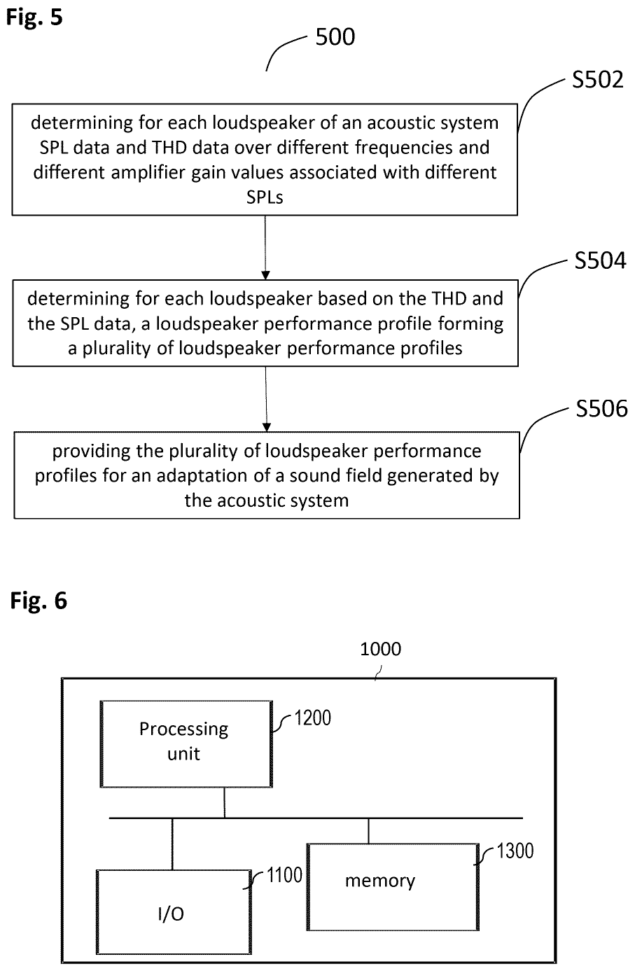

Method 400 is an exemplary implementation of method 500, further described in the context of FIG. 5.

Method 400 may comprise the steps S402-S424. Method 400 may comprise: at step S402, receiving frequency data; at step S404, receiving gain data; at step S406, generating a sine tone; at step S408, reproducing the sine tone by a first loudspeaker from multiple loudspeakers of an acoustic system; at step S410, method 400 may comprise recoding reproduced sound; at step S412, obtaining sound pressure level, SPL; at step S414, calculating total harmonic distortion, THD; at step S416, when the THD is below a threshold, increasing amplifier gain until the THD reaches the threshold; at step S418, repeating the preceding steps for each loudspeaker from the multiple loudspeakers; at step S420, for each loudspeaker, generating a loudspeaker performance profile; at step S422, from loudspeaker performance profiles, identifying settings for equalizing filter(s) and/or cross-over filter(s) at different amplifier gains; and, at step S424, applying the one or more filter settings for automated tunning of a sound field generated by the acoustic system.

Steps S402 to S418 of method 400 may be summarized by step S502 of method 500 as further described in the context of FIG. 5. Step S420 of method 400 may be summarized by step S504 of method 500 as further described in the context of FIG. 5. Steps S422 to S424 of method 400 may be summarized by step S506 of method 500 as further described in the context of FIG. 5.

FIG. 5 schematically shows a method 500 according to one of a number of embodiments.

The method 500 comprises steps S502, S504, S506.

The method 500 is carried out at a processing entity. The processing entity may comprise at least one computer processor. The method 500 comprises determining, at step S502, for each loudspeaker of an acoustic system comprising multiple loudspeakers, sound pressure level, SPL, data and total harmonic distortion, THD, data over different frequencies and different amplifier gain values associated with different SPLs. The method 500 further comprises determining, at step S504, for each loudspeaker based on the THD and the SPL data, a loudspeaker performance profile forming a plurality of loudspeaker performance profiles. The method 500 comprises providing, at step S506, the plurality of loudspeaker performance profiles for an adaptation of a sound field generated by the acoustic system.

In some examples, the determining, at step S502, may involve controlling, by the processing entity, a measurement module 202 and an analysis module 204 (as described in the context of FIG. 2a) to determine THD and SPL over a range of frequencies and system gain levels (amplifier gain values). The amplifier gain values may refer to gain levels or values controlled by an amplifier output knob. The amplifier may refer to an amplifier of the acoustic system. The determining, at step S502, may further involve collecting THD/SPL data in a grid (or matrix) of THD/SPL values for all frequency and amplifier gain levels. The method 500 may further involve providing THD/SPL data to a sound management system which can make use of it to set up the optimal acoustic system tunning parameters (e.g. equalizer, EQ, and cross-over filters) for different amplifier gain levels.

FIG. 6 schematically shows a processing entity 1000 according to one of a number of embodiments.

More specifically, FIG. 6 shows a schematic architectural view of the entity 1000 which can carry out the above method steps (e.g., steps of methods 400 and 500 as described in the context of FIGS. 4 and 5). The entity 1000 may be incorporated into any module (e.g., module 202 and/or 204 in FIG. 2a). The entity 1000 may comprise an interface 1100 which is provided for transmitting data to or control analysis of data by other entities via a transmitter and for receiving data from other entities using a receiver. The interface may be referred to as input/output interface (I/O). The interface 1100 is especially qualified to receive measurement data (e.g., frequency data 210, gain data 212, recorded signal at step S212 in FIG. 2a). The interface 1100 is further qualified to transmit analysed data (THD/SPL data 214 in FIG. 2a, acoustic system tunning parameters) to another entity (e.g., a memory, acoustic system 100). The entity 1000 furthermore comprises a processing unit 1200 which is responsible for the operation of the entity 1000. The processing unit 1200 comprises at least one computer processor and can carry out instructions stored on a memory 1300, wherein the memory may include a read-only memory, a random access memory, a mass storage, a hard disk or the like. The memory can furthermore include suitable program code (computer readable instructions) to be executed by the processing unit 1200 so as to implement the above described functionalities in which the entity is involved. The entity 1000 can be implemented in a single node or may be distributed over several nodes or entities in a cloud implementation. Each node or entity may comprise a computer processor, a computer memory, a computer interface or may be implemented on a cloud platform. For example, a first computer processor of entity 1000 may control a second computer processor of module 202 and a third computer processor of module 204 to determine THD/SPL data and to further determine acoustic system tunning parameters. The first computer processor may receive and/or transmit data (acoustic system tunning parameters) to a cloud and/or a fourth computer processor of acoustic system 100 for adaptation of sound field generated by the acoustic system 100. The first computer processor may receive measurement data (e.g., recorded sound) from the second computer processor and/or cloud. The first computer processor may receive data (e.g., THD/SPL data) from the third computer processor and/or cloud.

In an aspect, a processing entity 1000 is used for acoustic system 100 comprising multiple loudspeakers. The processing entity 1000 is adapted to carry out method steps S502-S506. The processing entity 1000 comprises at least one computer processor. The processing entity may be further adapted to carry out method steps S402-S424.

More specifically, the processing entity 1000 may control measurement module 202, as described in the context of FIG. 2a, to carry out steps S408 to S414. The processing entity 1000 may control an analysis module 204 to analyze the measurement data (recorded sound) as described in the context of steps S414 to S420. The processing entity 1000 may further identify acoustic system tunning parameters such as the ones described in the context of step S422 and cause the acoustic system to apply them as described in the context of step S424.

In some examples, the processing entity 1000 may apply acoustic system tunning parameters to manage sound field generated by the acoustic system 100, thereby providing sound field management. Thus, the processing entity 1000 may also be referred to as a sound field management system of the acoustic system.

One advantage of the method and the system of the current disclosure is that detailed information may be gained about how the multiple loudspeakers can best be used together. This detailed information is gathered in the plurality of loudspeaker performance profiles. Thus, the plurality of loudspeaker performance profiles can provide a structured information allowing for automatically tune the multiple loudspeakers jointly for joint optimal performance. In other words, the plurality of loudspeaker performance profiles can provide a data structure (identifiers of loudspeakers, grouping information by loudspeaker types and/or spatial regions, THD/SPL information structured in a matrix of values over frequencies and amplifiers gains) that allows to automatically identify acoustic system tunning parameters (EQs, cross-over filters). Furthermore, the data structure of the plurality of loudspeaker performance profiles may allow for automatically grouping acoustic system tunning parameters according to amplifier gain values. The grouped acoustic system tunning parameters can provide additional data that may allow to automatically select a suitable set of parameters when amplifier gain value changes, necessitating applying a new (suitable) set of parameters for the new (changed) gain value.

Thus, as may be inferred from the above disclosure, combined output of multiple loudspeakers together may be optimized, and not just the performance of one or some loudspeakers individually from the multiple loudspeakers.

In view of the above, general conclusions can be drawn that may be summarised by the following examples.

In some examples, providing the plurality of loudspeaker performance profiles for the adaptation may comprise adapting acoustic system tunning parameters. The acoustic system tunning parameters may be used for automated tunning of the sound field generated by the acoustic system. The acoustic system tunning parameters may comprise settings of one or more equalizing filters and one or more cross-over filters determined based on the plurality of loudspeaker performance profiles.

In some examples, determining the SPL and the THD data may comprise receiving frequency data comprising one or more frequency values covering an initial frequency range. The determining may further comprise receiving, by the processing entity, gain data comprising the amplifier gain values. The determining may further comprise generating, by the processing entity, a reference signal comprising a first sine tone within the initial frequency range for a first gain value of the gain data. The determining may further comprise causing, by the processing entity, a first loudspeaker from the multiple loudspeakers outputting an acoustic sound to reproduce the first sine tone. The determining may further comprise causing, by the processing entity, at least one acoustic detector placed at at least one listening position to record reproduced acoustic sound. The determining may further comprise obtaining, by the processing entity, first values of sound pressure level, SPL, from recorded sound. The determining may further comprise calculating, by the processing entity, a first value of the THD from the recorded sound. The determining may further comprise, when the first value of the THD is below a first threshold value, increasing amplifier gain to a subsequent amplifier gain value of the gain data until a subsequent value of the THD reaches the first threshold value and obtaining, by the processing entity, a corresponding value of sound pressure level, SPL, at each frequency value of the initial frequency range. The determining may further comprise repeating the preceding steps for each loudspeaker from the multiple loudspeakers.

In some examples, determining the loudspeaker performance profile may comprise, for each loudspeaker from the multiple loudspeakers, generating, by the processing entity, the loudspeaker performance profile forming the plurality of loudspeaker performance profiles, each loudspeaker performance profile comprising a loudspeaker identifier, at least one value of the THD associated with the first threshold value and with the initial frequency range, and further comprising at least one value of the SPL associated with the first threshold value and with the initial frequency range.

In some examples, providing the plurality of loudspeaker performance profiles for the adaptation may comprise identifying, by the processing entity from the plurality of loudspeaker performance profiles, one or more settings for one or more equalizing filters and/or one or more cross-over filters at different amplifier gain values. In some examples, the processing entity may be configured to cause the acoustic system to apply the one or more filter settings for automated tunning of the sound field.

In some examples, the one or more settings for the equalizing filter may comprise one or more equalizing filter parameters (e.g., frequency bands and one or more equalizer gain values associated with the one or more frequency bands; and/or one or more quality factors) for room response correction. In some examples, the method may further comprise adapting the one or more equalizer gain values according to one or more SPL values of the plurality of loudspeaker performance profiles.

In some examples, the one or more settings for each of the one or more cross-over filters may comprise at least one cut-off frequency value identified based on the THD and the SPL data of each of the plurality of loudspeaker performance profiles thereby optimizing joint performance of the multiple loudspeakers.

In some examples, the method may comprise determining a plurality of tunning parameter sets, each tunning parameter set being determined for a different amplifier gain value from the gain data and each tunning parameter set being determined from the one or more settings for the one or more equalizing filters and the one or more cross-over filters. The method may further comprise automatically selecting a tunning parameter set from the plurality of tunning parameter sets for a corresponding amplifier gain value. The method may further comprise causing the acoustic system to apply selected tunning parameter set for the adaptation of the sound field generated by the acoustic system, wherein the adaptation is triggered by an amplifier gain change.

In some examples, the method may comprise, determining, from the plurality of the loudspeaker performance profiles, a pair of candidate loudspeakers in the same spatial region, the pair of candidate loudspeakers having at least one common cross-over frequency range and determining across-over frequency for the pair of candidate loudspeakers. When the pair of candidate loudspeakers are available in the same spatial region, the method may further comprise selecting a candidate loudspeaker from the pair having a higher SPL value for the same or lower THD value as compared to the other candidate of the pair, wherein the pair of candidate loudspeakers comprise two loudspeakers of different types.

In some examples, the method may comprise grouping one or more loudspeakers from the multiple loudspeakers into at least two spatial regions comprising a first spatial region and a second spatial region for a cross-region adjustment of the one or more settings of the one or more cross-over filters. The first spatial region may comprise at least a first loudspeaker and the second spatial region comprises at least a second loudspeaker. The method may further comprise identifying the one or more settings of the one or more cross-over filter based on a loudspeaker performance profile of the first loudspeaker and a loudspeaker performance profile of the second loudspeaker.

In some examples, the method may comprise identifying at least two loudspeakers of at least two types, the at least two loudspeakers being located at at least one spatial region for cross-type adjustments of the one or more settings of the cross-over filter. The at least two loudspeakers may comprise a loudspeaker of a first type and a loudspeaker of a second type. The method may further comprise identifying the one or more settings for the cross-over filter based on a loudspeaker performance profile of the loudspeaker of the first type and a loudspeaker performance profile of the loudspeaker of the second type.

In some examples, the method may comprise recording reproduced acoustic sound by the at least one acoustic detector placed at multiple listening positions comprising at least two listening positions. The method may further comprise identifying the one or more settings for the cross-over filter for each loudspeaker for the multiple listening positions. The method may further comprise pairing the multiple loudspeakers into one or more pairs by type and by one or more spatial regions, each pair comprising at least two different types of loudspeakers located in the same or different spatial regions; and identifying one or more relative settings for a cross-over filter between loudspeakers of each pair for the multiple listening position for the adaptation of the sound field at the multiple listening positions. The method may optionally comprise, when the one or more pairs comprises more than one pair, identifying one or more optimal relative settings for cross-over filters for corresponding pairs of loudspeakers.

In some examples, the method may comprise (when the first value or the subsequent value of the THD reaches the first threshold value, and when the first loudspeaker's frequency range exceeds the initial frequency range) selecting a higher or a lower frequency range relative to the initial frequency range and resetting the amplifier gain value to an initial gain value for calculating another value of the THD associated with the higher or the lower frequency range and the initial gain value.

In some examples, obtaining the subsequent value of the THD and the corresponding SPL value comprises (for the initial frequency range from the frequency data and a subsequent amplifier gain value from the gain data) comprises: generating, by the processing entity, a subsequent sine tone; causing, by the processing entity, the first loudspeaker to reproduce the subsequent sine tone; causing, by the processing entity, the at least one acoustic detector to record reproduced sound; and calculating, by the processing entity, the subsequent value of the THD and the corresponding SPL value reproducing the subsequent sine tone by the first loudspeaker; recording reproduced sound by the at least one acoustic detector; and calculating the subsequent value of the THD and the corresponding SPL value.

In some examples, the method may comprise repeating the steps of preceding examples for at least a second threshold value and updating the loudspeakers performance profile to comprise THD values associated with the first and the second threshold values resulting in a plurality of the THD values and the SPL values for a plurality of threshold values comprising at least the first and the second threshold values.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices. The methods may be performed by executing stored instructions with one or more logic devices (e.g., processors) in combination with one or more additional hardware elements, such as storage devices, memory, hardware network interfaces/antennae, switches, actuators, clock circuits, etc. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated (e.g., a processor does not exclude plural of processors). Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

### REFERENCE SIGNS

100: an acoustic system;
102: a room;
104: a pair of speakers within a region;
106: a pair of speakers within a region;
108: a pair of speakers within a region;
110: a pair of speakers withing a region;
112: a right-side spatial region for a 3-way speaker system;
114: a left-side spatial region for a 3-way speaker system;
116: a tweeter;
118: a mid-range;
120: a woofer;
122: listening positions;
124: a transverse axis;
126: a longitudinal axis;
128: a cross-over response across regions;
200a: an embodiment for obtaining THD and SPL data;
202: a measurement module;
204: an analysis module;
206: an iterative measurement loop;
208: initial conditions;
210: frequency data;
212: gain data;
214: THD/SPL data;
200b: an embodiment for generating and using a per-speaker performance profile for automatic tunning of an acoustic system;
218: automated THD measurements (comprising measurement 202 and analysis 204 modules);
220: per speaker performance profile (comprising, e.g., THD/SPL data 214, speaker identifiers, threshold values and gains);
224: automated cross-over identification;
226: room response correction adaptation;
228: optimal acoustic system configuration;
200c: an embodiment for automatic tunning of an acoustic system;
230: a change in SPL;
232: an acoustic system configuration;
234: updating playback system;
S202: start an iterative measurement loop;
S204: provide initial conditions;
S206: provide frequency and gain data;
S208: generate a sine tone;
S210: reproduce the sine tone;
S212: record reproduced sound;
S214: calculate THD/SPL data;
S216: store THD/SPL data;
S218: if a THD threshold is reached, check if speaker's frequency range is covered;
S220: if the range is covered, check if all speakers are measured;
S222: if all speakers are measured, end the process;
S224: if the THD threshold is not reached, increase gain and start the measurement loop;
S226: if the frequency range is not covered, change the frequency range, reset gain and start the measurement loop;
S228: if not all speakers are measured, move to next speaker and start the measurement loop;
300a: a loudspeaker performance profile 300a of a mid-range loudspeaker showing a maximum SPL value produced over frequency for a given THD threshold value;
300b: SPL and THD data for a 3-way loudspeaker system from which optimal cross-over settings for a cross-over filter can be determined;
400: a method;
S402: receiving frequency data;
S404: receiving gain data;
S406: generating a sine tone;
S408: reproducing the sine tone by a first loudspeaker from multiple loudspeakers of an acoustic system;
S410: recoding reproduced sound;
S412: obtaining sound pressure level, SPL;
S414: calculating total harmonic distortion, THD;
S416: when the THD is below a threshold, increasing amplifier gain until the THD reaches the threshold;
S418: repeating the preceding steps for each loudspeaker from the multiple loudspeakers;
S420: for each loudspeaker, generating a loudspeaker performance profile;
S422: from loudspeaker performance profiles, identifying settings for equalizing filter(s) and/or cross-over filter(s) at different amplifier gains;
S424: applying the one or more filter settings for automated tunning of a sound field generated by the acoustic system;
500: a method;
S502: determining for each loudspeaker of an acoustic system SPL data and THD data over different frequencies and different amplifier gain values associated with different SPLs;
S504: determining for each loudspeaker based on the THD and the SPL data, a loudspeaker performance profile forming a plurality of loudspeaker performance profiles;
S506: providing the plurality of loudspeaker performance profiles for an adaptation of a sound field generated by the acoustic system;
1000: a processing entity;
1100: I/O interface;
1200: a processing unit (a computer processor);
1300: a memory (electronic storage medium).

Any and all combinations of any of the claim elements recited in any of the claims and/or any elements described in this application, in any fashion, fall within the contemplated scope of the present disclosure and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module,” a “system,” or a “computer.” In addition, any hardware and/or software technique, process, function, component, engine, module, or system described in the present disclosure can be implemented as a circuit or set of circuits. Furthermore, aspects of the present disclosure can take the form of a computer program product embodied in one or more computer readable medium having computer readable program code embodied thereon.

Any combination of one or more computer readable medium can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function. It should also be noted that, in some alternative implementations, the functions noted in the block can occur out of the order noted in the figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow.

What is claimed is:

1. A method carried out at a processing entity, comprising the steps of:
determining, for each loudspeaker of an acoustic system comprising multiple loudspeakers, sound pressure level (SPL) data and total harmonic distortion (THD) data over different frequencies and different amplifier gain values associated with different SPLs;
determining, for each loudspeaker based on the THD and the SPL data, a loudspeaker performance profile forming a plurality of loudspeaker performance profiles; and
providing the plurality of loudspeaker performance profiles for an adaptation of a sound field generated by the acoustic system.

2. The method of claim 1, wherein providing for the adaptation comprises:
adapting acoustic system tuning parameters for automated tuning of the sound field generated by the acoustic system,
wherein the acoustic system tuning parameters comprise settings of one or more equalizing filters and one or more cross-over filters determined based on the plurality of loudspeaker performance profiles.

3. The method of claim 2, wherein determining the SPL and the THD data comprises:
for each loudspeaker from the multiple loudspeakers:
receiving frequency data comprising one or more frequency values covering an initial frequency range;
receiving gain data comprising the amplifier gain values;
generating a reference signal comprising a first sine tone within the initial frequency range for a first gain value of the gain data;
causing, a first loudspeaker from the multiple loudspeakers outputting an acoustic sound to reproduce the first sine tone;
causing, at least one acoustic detector placed at at least one listening position to record reproduced acoustic sound;
obtaining first values of sound pressure level (SPL) from recorded sound;
calculating a first value of the THD from the recorded sound;
when the first value of the THD is below a first threshold value, increasing amplifier gain to a subsequent amplifier gain value of the gain data until a subsequent value of the THD reaches the first threshold value and obtaining, by the processing entity, a corresponding value of sound pressure level, SPL, at each frequency value of the initial frequency range;
wherein determining the loudspeaker performance profile comprises:
for each loudspeaker from the multiple loudspeakers, generating the loudspeaker performance profile forming the plurality of loudspeaker performance profiles, each loudspeaker performance profile comprising a loudspeaker identifier, at least one value of the THD associated with the first threshold value and with the initial frequency range, and further comprising at least one value of the SPL associated with the first threshold value and with the initial frequency range;
and wherein providing for the adaptation further comprises:
from the plurality of loudspeaker performance profiles, identifying one or more settings for one or more equalizing filters or one or more cross-over filters at different amplifier gain values; and
causing the acoustic system to apply one or more filter settings for automated tunning of the sound field.

4. The method of claim 3, further comprising:
recording reproduced acoustic sound by the at least one acoustic detector placed at multiple listening positions comprising at least two listening positions; and
identifying the one or more settings for the cross-over filter for each loudspeaker for the multiple listening positions,
pairing the multiple loudspeakers into one or more pairs by type and by one or more spatial regions, each pair comprising at least two different types of loudspeakers located in a same or different spatial regions; and
identifying one or more relative settings for a cross-over filter between loudspeakers of each pair for the multiple listening position for the adaptation of the sound field at the multiple listening positions, and optionally, when the one or more pairs comprises more than one pair, identifying one or more optimal relative settings for cross-over filters for corresponding pairs of loudspeakers.

5. The method of claim 3, further comprising:
when the first value or the subsequent value of the THD reaches the first threshold value, and when the first loudspeaker's frequency range exceeds the initial frequency range, selecting a higher or a lower frequency range relative to the initial frequency range and resetting the amplifier gain to an initial gain value for calculating another value of the THD associated with the higher or the lower frequency range and the initial gain value.

6. The method of claim 3:
wherein obtaining the subsequent value of the THD and the corresponding SPL value comprises the steps of:
for the initial frequency range from the frequency data and a subsequent amplifier gain value from the gain data, generating, by the processing entity, a subsequent sine tone;
causing, by the processing entity, the first loudspeaker to reproduce the subsequent sine tone;
causing, by the processing entity, the at least one acoustic detector to record reproduced sound; and
calculating, by the processing entity, the subsequent value of the THD and the corresponding SPL value.

7. The method of claim 3:
wherein the one or more settings for the equalizing filter comprises one or more equalizing filter parameters for room response correction,
and wherein the method further comprises adapting the one or more amplifier gain values according to one or more SPL values of the plurality of loudspeaker performance profiles.

8. The method of claim 3:
wherein the one or more settings for each of the one or more cross-over filters comprises at least one cut-off frequency value identified based on the THD and the SPL data of each of the plurality of loudspeaker performance profiles thereby optimizing joint performance of the multiple loudspeakers.

9. The method of claim 3, further comprising:
determining a plurality of tunning parameter sets, each tunning parameter set being determined for a different amplifier gain value from the gain data and each tunning parameter set being determined from the one or more settings for the one or more equalizing filters and the one or more cross-over filters;
automatically selecting a tunning parameter set from the plurality of tunning parameter sets for a corresponding amplifier gain value; and
causing the acoustic system to apply selected tunning parameter set for the adaptation of the sound field generated by the acoustic system, wherein the adaptation is triggered by an amplifier gain change.

10. The method of claim 3, further comprising:
grouping one or more loudspeakers from the multiple loudspeakers into at least two spatial regions comprising a first spatial region and a second spatial region for a cross-region adjustment of the one or more settings of the one or more cross-over filters,
wherein the first spatial region comprises at least a first loudspeaker and the second spatial region comprises at least a second loudspeaker; and
identifying the one or more settings of the one or more cross-over filter based on a loudspeaker performance profile of the first loudspeaker and a loudspeaker performance profile of the second loudspeaker.

11. The method of claim 3, further comprising:
identifying at least two loudspeakers of at least two types, the at least two loudspeakers being located at at least one spatial region for cross-type adjustments of the one or more settings of the cross-over filter, wherein the at least two loudspeakers comprise a loudspeaker of a first type and a loudspeaker of a second type,
and identifying the one or more settings for the cross-over filter based on a loudspeaker performance profile of the loudspeaker of the first type and a loudspeaker performance profile of the loudspeaker of the second type.

12. The method of claim 3, further comprising:
updating the loudspeakers performance profile for at least a second threshold value and to comprise THD values associated with the first and the second threshold values resulting in a plurality of the THD values and the SPL values for a plurality of threshold values comprising at least the first and the second threshold values.

13. The method of claim 1, further comprising:
from the plurality of the loudspeaker performance profiles, determining a pair of candidate loudspeakers in a same spatial region, the pair of candidate loudspeakers having at least one common cross-over frequency range and determining across-over frequency for the pair of candidate loudspeakers,
when the pair of candidate loudspeakers are available in the same spatial region, selecting a candidate loudspeaker from the pair having a higher SPL value for a same or lower THD value as compared to the other candidate of the pair, wherein the pair of candidate loudspeakers comprise two loudspeakers of different types.

14. A system comprising:
a memory storing an application; and
a processor coupled to the memory that executes the application by performing the steps of:
determining, for each loudspeaker of an acoustic system comprising multiple loudspeakers, sound pressure level (SPL) data and total harmonic distortion (THD) data over different frequencies and different amplifier gain values associated with different SPLs;
determining, for each loudspeaker based on the THD and the SPL data, a loudspeaker performance profile forming a plurality of loudspeaker performance profiles; and
providing the plurality of loudspeaker performance profiles for an adaptation of a sound field generated by the acoustic system.

15. The system of claim 14, wherein providing for the adaptation comprises:
adapting acoustic system tuning parameters for automated tuning of the sound field generated by the acoustic system,
wherein the acoustic system tuning parameters comprise settings of one or more equalizing filters and one or more cross-over filters determined based on the plurality of loudspeaker performance profiles.

16. The system of claim 15, wherein determining the SPL and the THD data comprises:
for each loudspeaker from the multiple loudspeakers:
receiving frequency data comprising one or more frequency values covering an initial frequency range;
receiving gain data comprising the amplifier gain values;
generating a reference signal comprising a first sine tone within the initial frequency range for a first gain value of the gain data;
causing, a first loudspeaker from the multiple loudspeakers outputting an acoustic sound to reproduce the first sine tone;
causing, at least one acoustic detector placed at at least one listening position to record reproduced acoustic sound;
obtaining first values of sound pressure level (SPL) from recorded sound; calculating a first value of the THD from the recorded sound;
when the first value of the THD is below a first threshold value, increasing amplifier gain to a subsequent amplifier gain value of the gain data until a subsequent value of the THD reaches the first threshold value and obtaining, by the processor, a corresponding value of sound pressure level, SPL, at each frequency value of the initial frequency range; wherein determining the loudspeaker performance profile comprises: for each loudspeaker from the multiple loudspeakers, generating the loudspeaker performance profile forming the plurality of loudspeaker performance profiles, each loudspeaker performance profile comprising a loudspeaker identifier, at least one value of the THD associated with the first threshold value and with the initial frequency range, and further comprising at least one value of the SPL associated with the first threshold value and with the initial frequency range;
and wherein providing for the adaptation further comprises from the plurality of loudspeaker performance profiles, identifying one or more settings for one or more equalizing filters or one or more cross-over filters at different amplifier gain values; and
causing the acoustic system to apply one or more filter settings for automated tunning of the sound field.

17. The system of claim 14, further comprising:
updating the loudspeakers performance profile for at least a second threshold value and to comprise THD values associated with a first and the second threshold values resulting in a plurality of the THD values and the SPL values for a plurality of threshold values comprising at least the first and the second threshold values.

18. The system of claim 14, further comprising:
from the plurality of the loudspeaker performance profiles, determining a pair of candidate loudspeakers in a same spatial region, the pair of candidate loudspeakers having at least one common cross-over frequency range and determining across-over frequency for the pair of candidate loudspeakers,
when the pair of candidate loudspeakers are available in the same spatial region, selecting a candidate loudspeaker from the pair having a higher SPL value for a same or lower THD value as compared to the other candidate of the pair, wherein the pair of candidate loudspeakers comprise two loudspeakers of different types.

19. One or more non-transitory computer-readable media storing instructions that, when executed by one or more processors, cause the one or more processors to perform the steps of:
determining, for each loudspeaker of an acoustic system comprising multiple loudspeakers, sound pressure level (SPL) data and total harmonic distortion (THD) data over different frequencies and different amplifier gain values associated with different SPLs;
determining, for each loudspeaker based on the THD and the SPL data, a loudspeaker performance profile forming a plurality of loudspeaker performance profiles; and
providing the plurality of loudspeaker performance profiles for an adaptation of a sound field generated by the acoustic system.

20. The one or more non-transitory computer-readable media of claim 19, wherein providing for the adaptation comprises:
adapting acoustic system tuning parameters for automated tuning of the sound field generated by the acoustic system,
wherein the acoustic system tuning parameters comprise settings of one or more equalizing filters and one or more cross-over filters determined based on the plurality of loudspeaker performance profiles.
